(19) United States
(12) Patent Application Publication
(10) Pub. No.: US 2026/0032506 A1
(43) Pub. Date: Jan. 29, 2026

(54) METHODS AND APPARATUS FOR HANDLING PDU SETS IN XR TRAFFIC

(71) Applicant: APPLE INC., Cupertino, CA (US)

(72) Inventors: Ping-Heng Kuo, London (GB); Fangli Xu, Beijing (CN); Ralf Rossbach, Munich (DE); Haijing Hu, Los Gatos, CA (US)

(21) Appl. No.: 18/995,336

(22) PCT Filed: Aug. 3, 2022
(86) PCT No.: PCT/CN2022/110064

§ 371 Date: Jan. 16, 2025

(51) Int. Cl. H04W 28/02; H04W 72/21

(52) U.S. Cl. CPC H04W 28/0278; H04W 72/21

(57) ABSTRACT

Methods and apparatus are provided for handling protocol data unit (PDU) sets. A user equipment (UE) determines that buffered uplink data at a logical channel (LCH) of the UE corresponds to a first protocol data unit (PDU) set type. The UE indicates, to a base station, that the buffered uplink data at the LCH of the UE corresponds to the first PDU set type. The UE processes a dynamic grant from the base station corresponding to the first PDU set type.

### TECHNICAL FIELD

This application relates generally to wireless communication systems, including wireless communication systems with extended reality (XR) downlink and uplink communications.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates example PDU sets that may be used in XR communications in certain embodiments.

FIG. 2 illustrates example PDU sets indicated as important and not important according to certain embodiments.

FIG. 3 is a flowchart of a method for wireless communication by a UE according to one embodiment.

FIG. 4 is a flowchart of a method for wireless communication by a base station according to one embodiment.

FIG. 5 is a flowchart of a method for a wireless device according to certain embodiments.

FIG. 6 illustrates an example architecture of a wireless communication system, according to embodiments disclosed herein.

FIG. 7 illustrates a system for performing signaling between a wireless device and a network device, according to embodiments disclosed herein.

FIG. 8 illustrates an example service based architecture in accordance with certain embodiments.

FIG. 9A illustrates an example of a user plane protocol stack in accordance with one embodiment.

FIG. 9B illustrates an example of a control plane protocol stack in accordance with one embodiment.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

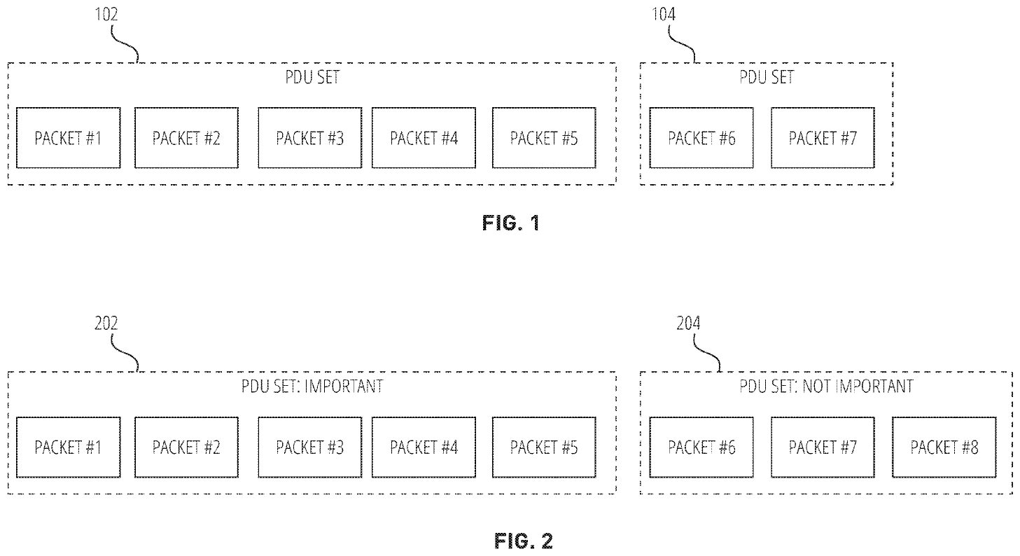

Extended reality (XR) applications may include, for example, virtual reality (VR), mixed reality (MR), and/or augmented reality (AR) downlink and uplink communications. XR services can operate on a protocol data unit (PDU) set, which includes multiple internet protocol (IP) packets or PDUs. For example, FIG. 1 illustrates example PDU sets that may be used in XR communications in certain embodiments. A first PDU set 102 includes a plurality of IP packets (shown as Packet #1, Packet #2, Packet #3, Packet #4, and Packet #5). A second PDU set 104 includes a plurality of IP packets (shown as Packet #6 and Packet #7). Skilled persons will recognize from the disclosure herein that the first PDU set 102 and/or the second PDU set 104 may comprise more or fewer IP packets (or PDUs) and that XR traffic may use any number of PDU sets.

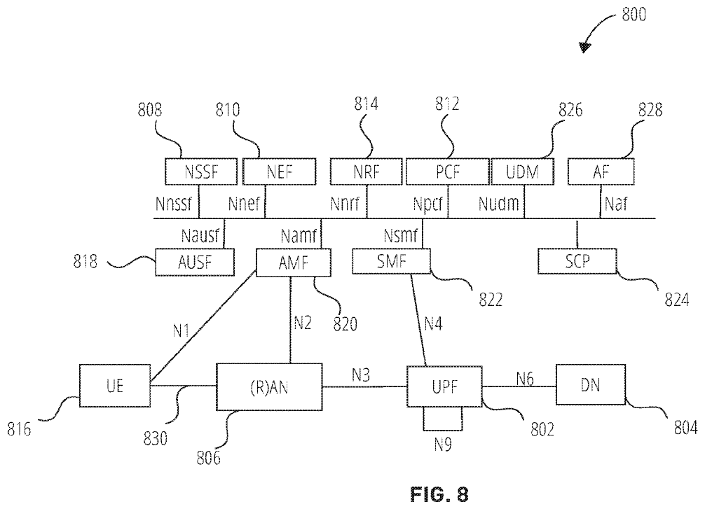

A user plane function (UPF) (e.g., UPF 802 shown in FIG. 8), may identify a PDU set based on PDU set sequence number (SN), start/end PDU of the PDU set, PDU SN within a PDU set, or the number of PDUs within a PDU set. The UPF also provides the information relating to PDU sets to the RAN. Such information may include, for example, quality of service (QOS) flow information.

PDU sets may be mapped to different QoS flows. The QoS flow may be identified using a QoS flow identifier (ID) and each PDU set within the QoS slow may be identified using a PDU set SN. Each QoS flow can be used to deliver one or more PDU set. New QoS parameters for PDU sets based QoS handling may be defined in a 5G system (5GS), such as PDU set delay budget (PSDB), PDU set error rate (PSER), a parameter to indicate whether to drop a PDU set in case the PSDB is exceeded, a parameter to indicate whether all PDUs within a PDU set are needed for the usage of the PDU set by the application layer, and/or a PDU set priority.

The UPF may further identify information relating to each PDU set, such as PDU set importance and PDU set dependency. A “PDU set importance” parameter indicates how important the PDU set (e.g. a video frame) is for the application. For examples, an important PDU set for a video frame may be an intra-coded frame (I-frame), while a less important PDU set may be a predictive frame (P-frame) or a bi-directional frame (B-frame). Video decoding generally comprises three frame types, I-frames, P-frames, and B-frames. H.264 allows other types of coding such as switching I (SI) and switching P (SP) in the extended profile (EP). I-frames are generally more important to a video codec than P-frames, and P-frames are generally more important to a video codec than B-frames. B-frames are dependent on previous I-frames and P-frames. A group of pictures (GOP) may contain each of I-frames (i.e., one I-frame per GOP in MPEG2), P-frames, and B-frames. The I-frames may contain the full image (e.g., the complete image may be reconstructed during decoding by using only data of the I-frame).

In certain communication systems, the RAN can obtain the information of importance for each PDU set (e.g., from the core network or from an application). For example, FIG. 2 illustrates example PDU sets indicated as important and not important according to certain embodiments. Skilled persons will recognize from the disclosure herein that other embodiments may use more than two levels (i.e., important or not important), and that multiple levels or degrees of priority may also be used. In the example shown in FIG. 2, a first PDU set 202 in indicated as important and includes a plurality of IP packets (shown as Packet #1, Packet #2, Packet #3, Packet #4, and Packet #5). A second PDU set 204 is indicated as not important and includes a plurality of IP packets (shown as Packet #6, Packet #7, and Packet #8). Skilled persons will recognize from the disclosure herein that the first PDU set 202 and/or the second PDU set 204 may comprise more or fewer IP packets (or PDUs) and that any number of PDU sets may be used.

Important PDU sets may be treated with better reliability, while non-important PDU sets can be processed in a more relaxed manner. For example, the RAN can allocate more radio resources for a UE to use for transmitting the first PDU set 202 and less resources for the UE to use for transmitting the second PDU set 204. Thus, by having PDU set importance information, the RAN can allocate or use radio resources more efficiently.

Important PDU sets and non-important PDU sets may be mapped to different QoS flows and handled by different data radio bearers (DRBs). However, from a UE implementation perspective, it may be less desirable to process one traffic flow with multiple DRBs as this is more resource and/or battery consuming. Furthermore, due to UE capability constraints, there may be an upper limit of the maximum number of DRBs that can be established for a UE concurrently. Thus, using too many DRBs for a single service may be inappropriate if the UE needs to serve multiple applications simultaneously.

On the other hand, a single QoS flow may include both an important PDU set and a non-important PDU set. Hence, the important PDU set and the non-important PDU set could be mapped to the same DRB. Thus, it is useful to determine how a transmitter in a RAN can differentiate the handling for important PDU sets and non-important PDU sets in the same DRB. For downlink (DL), such handling may be determined by base station (e.g., gNB) implementation. For uplink (UL), however, it may not be as straightforward as the base station may not be able to predict when an important PDU set would arrive.

Thus, certain embodiments disclosed herein provide methods and apparatus for a RAN to use PDU set importance information for improved UL radio resource allocation.

### Buffer Status Report Enhancement

When traffic has arrived at the UE's transmit buffer, the UE may send a buffer status report (BSR) to the base station (e.g., gNB) so the base station knows how much data is pending (and for which radio bearer) at the UE. This allows the base station to schedule dynamic grants more appropriately.

In certain embodiments disclosed herein, the UE indicates in the BSR whether there is any data buffered at a logical channel pertaining to an important PDU set. Upon reception of the BSR, the base station knows if any buffered data corresponds to an important PDU set or not. Therefore, the base station can determine if physical uplink shared channel (PUSCH) parameters of a dynamic grant with a higher reliability target should be issued. For example, the base station may use the important PDU set information in the BSR from the UE to configure the UE (e.g., in downlink control information (DCI)) with a more reliable modulation and coding scheme (MCS) and/or number of repetitions.

In one embodiment, new fields are added in the existing BSR formats. The new fields indicate the presence of an important PDU set in at least one logical channel group (LCG).

In another embodiment, the UE indicates important PDU set information by using a different logical channel identifier (LCID) or extended LCID (eLCID) for the BSR media access control (MAC) control element (CE). So, depending on the LCID/eLCID of the BSR MAC CE, the base station knows if the buffered data indicated by the BSR corresponds to an important PDU set. With this approach, no additional field in the existing BSR formats is needed. For example, one of the currently reserved code point or index values in Table 6.2.1-2 of 3GPP Technical Specification (TS) 38.321 may be associated with the BSR MAC CE when there is at least one important PDU set in the UE's transmit buffer.

### Scheduling Request Enhancement

In the current scheduling request (SR) framework, a logical channel (LCH) may be mapped to zero or one SR configuration. An SR configuration includes a set of physical uplink control channel (PUCCH) resources for SR across different bandwidth parts (BWPs) and cells. Based on which PUCCH the base station has perceived with an SR, the base station knows which LCH(s) has triggered the SR.

In certain embodiments disclosed herein, for cases where the LCH of a DRB conveys data of both important PDU sets and non-important PDU sets, the LCH is mapped to two SR configurations. A first SR configuration is for an SR triggered by an important PDU set. A second SR configuration if for an SR triggered by a non-important PDU set. Depending on whether an important PDU set has arrived in the buffer of the LCH, the UE triggers the SR in either SR configuration. In other words, the UE triggers the SR with the first SR configuration when an important PDU set has arrived in the buffer, or the UE triggers the SR with the second SR configuration when no important PDU set has arrived in the buffer.

Therefore, by monitoring in which PUCCH resource the SR is received, the base station becomes aware of the importance of the PDU set that has arrived at the UE buffer. Upon reception of the SR, the base station knows based on the corresponding SR configuration if the packet arrival that triggers the SR corresponds to an important PDU set or not. The base station can then determine if PUSCH parameters of the dynamic grant with a higher reliability target should be issued (e.g. MCS and/or number of repetitions). In certain embodiments, the UE may include a BSR MAC CE in the issued grant, and the BSR MAC CE may include buffer status information for LCHs relating to both important PDU sets and non-important PDU sets.

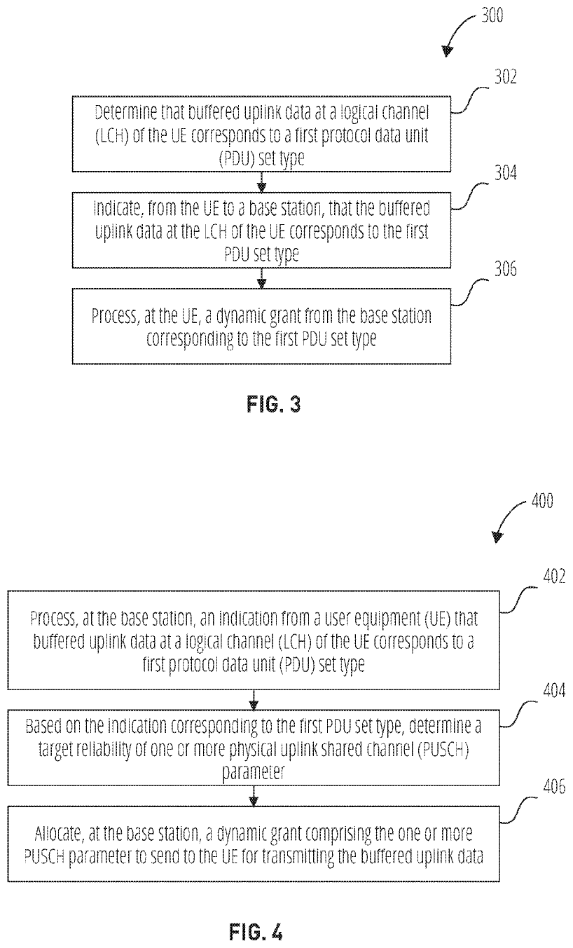

FIG. 3 and FIG. 4 provide example embodiments that may be used for BSR enhancement and SR enhancement, as discussed above.

FIG. 3 is a flowchart of a method 300 for wireless communication by a user equipment (UE) according to one embodiment. In block 302, the method 300 includes determining that buffered uplink data at a logical channel (LCH) of the UE corresponds to a first protocol data unit (PDU) set type. In block 304, the method 300 includes indicating, from the UE to a base station, that the buffered uplink data at the LCH of the UE corresponds to the first PDU set type. In block 306, the method 300 includes processing, at the UE, a dynamic grant from the base station corresponding to the first PDU set type.

In certain embodiments of the method 300, indicating that the buffered uplink data at the LCH of the UE corresponds to the first PDU set type includes altering one or more fields in a buffer status report (BSR) to indicate a presence of the first PDU set type in at least one logical channel group (LCG).

In certain embodiments of the method 300, indicating that the buffered uplink data at the LCH of the UE corresponds to the first PDU set type includes: using a first logical channel identifier (LCID) or a first extended LCID (eLCID) for a buffer status report (BSR) media access control (MAC) control element (CE) to indicate that the buffered uplink data corresponds to the first PDU set type; and using a second LCID or a second eLCID for the BSR MAC CE to indicate that the buffered uplink data corresponds to a second PDU set type.

In certain embodiments, the method 300 further includes receiving, at the UE from the base station, a first scheduling request (SR) configuration and a second SR configuration for the LCH, wherein the LCH corresponds to a data radio bearer (DRB) configured to carry data of both the first PDU set type and a second PDU set type, wherein a first SR triggered by first uplink data of the first PDU set type from the LCH is sent based on the first SR configuration, and wherein a second SR triggered by a second uplink data of the second PDU type from the LCH is sent based on the second SR configuration. In one embodiment, indicating that the buffered uplink data at the LCH of the UE corresponds to the first PDU set type comprises: trigging the SR with the first SR configuration when a first PDU set of the first PDU set type arrives at a transmit buffer of the UE; and triggering the SR with the second SR configuration when a second PDU set of the second PDU set type arrives at the transmit buffer of the UE. In addition, or in another embodiment, the method 300 includes generating a buffer status report (BSR) media access control (MAC) control element (CE) to send from the UE to the base station, wherein the BSR MAC CE comprises buffer status information corresponding to both the first PDU set type and the second PDU set type.

In certain embodiments of the method 300, the first PDU set type comprises an important PDU set of an extended reality (XR) traffic flow, and the second PDU set type comprises a non-important PDU set of the XR traffic flow.

FIG. 4 is a flowchart of a method 400 for wireless communication by a base station according to one embodiment. In block 402, the method 400 includes processing, at the base station, an indication from a user equipment (UE) that buffered uplink data at a logical channel (LCH) of the UE corresponds to a first protocol data unit (PDU) set type. In block 404, based on the indication corresponding to the first PDU set type, the method 400 includes determining a target reliability of one or more physical uplink shared channel (PUSCH) parameter. In block 406, the method 400 includes allocating, at the base station, a dynamic grant comprising the one or more PUSCH parameter to send to the UE for transmitting the buffered uplink data.

In certain embodiments of the method 400, the one or more PUSCH parameter comprises at least one of a modulation and coding scheme (MCS) and a number of repetitions for the UE to transmit the buffered uplink data.

In certain embodiments of the method 400, the indication from the UE that the buffered uplink data at the LCH of the UE corresponds to the first PDU set type comprises an alteration of one or more fields in a buffer status report (BSR) that indicate a presence of the first PDU set type in at least one logical channel group (LCG).

In certain embodiments of the method 400, the indication from the UE includes: a first logical channel identifier (LCID) or a first extended LCID (eLCID) in a buffer status report (BSR) media access control (MAC) control element (CE) to indicate when the buffered uplink data corresponds to the first PDU set type; and a second LCID or a second eLCID in the BSR MAC CE to indicate when the buffered uplink data corresponds to a second PDU set type.

In certain embodiments, the method 400 further includes configuring the UE with a first scheduling request (SR) configuration and a second SR configuration for the LCH, wherein the LCH corresponds to a data radio bearer (DRB) configured to carry data of both the first PDU set type and a second PDU set type, wherein a first SR triggered by first uplink data of the first PDU set type from the LCH is sent based on the first SR configuration, and wherein a second SR triggered by a second uplink data of the second PDU type from the LCH is sent based on the second SR configuration. In certain such embodiments, the method 400 further includes monitoring in which physical uplink control channel (PUCCH) the SR is received at the base station to determine whether the first SR configuration is used to indicate the first PDU set type or the second SR configuration is used to indicate the second PDU set type. In other embodiments, the method 400 further includes processing, at the base station, a buffer status report (BSR) media access control (MAC) control element (CE) from the UE including buffer status information corresponding to both the first PDU set type and the second PDU set type.

In certain embodiments of the method 400, the first PDU set type comprises an important PDU set of an extended reality (XR) traffic flow, and the second PDU set type comprises a non-important PDU set of the XR traffic flow.

### Conditional Packet Duplication

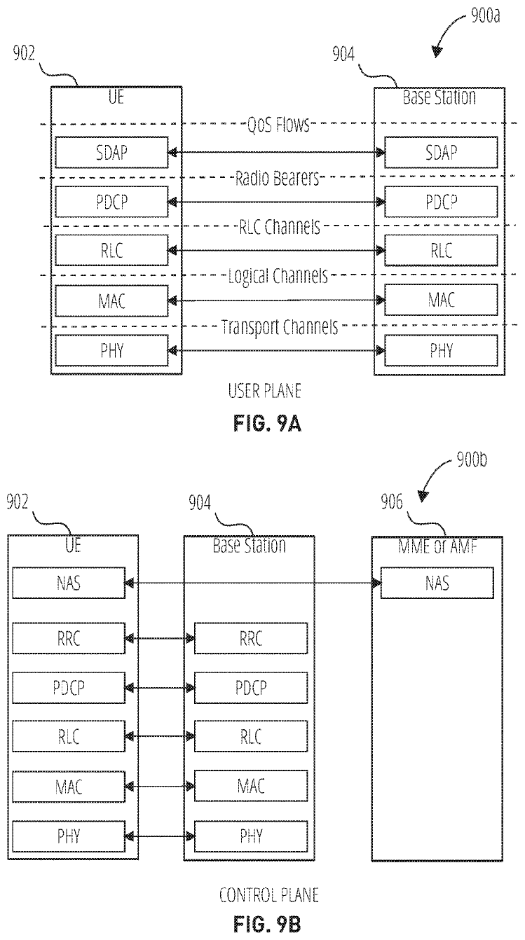

In certain embodiments, a packet data convergence protocol (PDCP) entity (sec, FIG. 9A and FIG. 9B) of the UE is configured to perform conditional packet duplication based on the PDU set importance (e.g., where the DRB has been configured with more than one radio link control (RLC) entities for packet duplication). For each important PDU set, the PDCP entity submits the packets within the important PDU set to multiple RLC entities for packet duplication. In one such embodiment, the PDCP entity submits all packets of the important PDU Set to all RLC entities configured for the DRB. In another embodiment, the PDCP entity submits all packets of the important PDU set to a selected group of the multiple RLC entities configured for the DRB, wherein the group is determined based on a previous instruction (e.g., RRC configuration or a MAC CE) from the base station.

For each non-important PDU set, the PDCP entity does not duplicate the packets within the non-important PDU set even if packet duplication is configured and/or activated (which may be determined by UE implementation). In one such embodiment, the PDCP entity submits all packets of the non-important PDU set to a primary RLC entity only (i.e., no packet duplication). In another embodiment, the PDCP entity submits only some packets of the non-important PDU set to multiple RLC entities configured for the DRB (i.e., only some packets are duplicated).

In another embodiment, when the network sends an explicit signaling to activate or deactivate PDCP duplication of a DRB (e.g., by sending a packet duplication activation/deactivation MAC CE), the network may further indicate whether the activation/deactivation command is applicable to only important PDU sets, only non-important PDU sets, or both types of PDU sets.

### Conditional RLC Leg Switching

In certain embodiments, the PDCP entity of the UE may be configured to perform conditional RLC leg switching based on the PDU set importance. The RLC entities are associated to logical channel (LCHs) with different settings such as priority, prioritized bit rate (PBR), and/or LCH mapping restrictions (e.g., assuming the DRB has been configured with more than one RLC entities for such purpose). For each important PDU set, the PDCP entity submits all the packets within the important PDU set to a first group of at least one RLC entity. For each non-important PDU set, the PDCP entity submits all the packets within the non-important PDU set to a second group of at least one RLC entity. In certain embodiments, the first group of at least one RLC entity and the second group of at least one RLC entity may be partially overlapping.

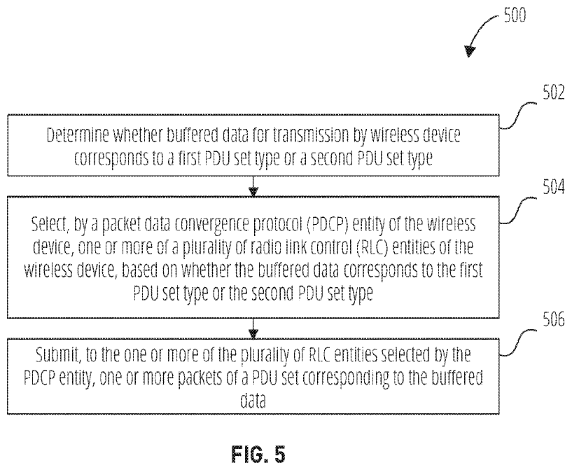

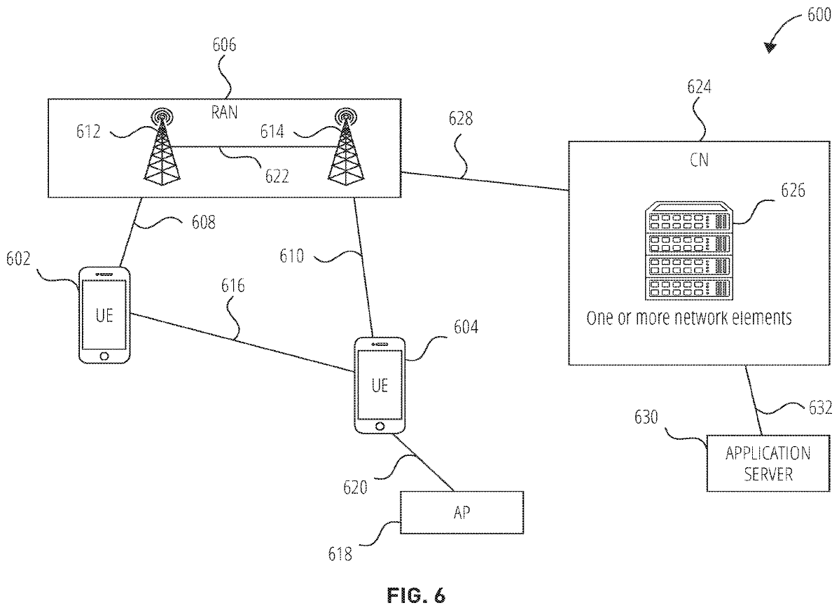

FIG. 5 is a flowchart of a method 500 for a wireless device according to certain embodiments. FIG. 5 provides examples that may be used for conditional packet duplication and/or conditional RLC leg switching, as discussed above. In particular, in block 502, the method 500 includes determining whether buffered data for transmission by the wireless device corresponds to a first protocol data unit (PDU) set type or a second PDU set type. In block 504, the method 500 includes selecting, by a packet data convergence protocol (PDCP) entity of the wireless device, one or more of a plurality of radio link control (RLC) entities of the wireless device, based on whether the buffered data corresponds to the first PDU set type or the second PDU set type. In block 506, the method 500 includes submitting, to the one or more of the plurality of RLC entities selected by the PDCP entity, one or more packets of a PDU set corresponding to the buffered data.

In certain embodiments, the method 500 further includes performing, by the PDCP entity of the wireless device, conditional packet duplication wherein when the buffered data corresponds to the first PDU set type, the PDCP entity submits a subset of the one or more packets of the PDU set, or each of the one or more packets of the PDU set, to at least two or more of the plurality of RLC entities configured for a corresponding data radio bearer (DRB) for packet duplication. The subset may include, for example, essential packets (e.g., as designated by an application) of an important PDU set.

In certain embodiments of the method 500, for the conditional packet duplication, when the buffered data corresponds to the first PDU set type, the PDCP entity submits a subset of the one or more packets of the PDU set, or each of the one or more packets of the PDU set, to each of the plurality of RLC entities configured for the corresponding DRB for duplication. The subset may include, for example, essential packets (e.g., as designated by an application) of an important PDU set.

In certain embodiments of the method 500, for the conditional packet duplication, when the buffered data corresponds to the first PDU set type, the PDCP entity submits each of the one or more packets of the PDU set to a selected group of the plurality of RLC entities configured for the corresponding DRB for packet duplication. In certain such embodiments, the wireless device comprises a user equipment (UE), and the method 500 further comprises receiving, at the UE from a base station, an indication of the selected group.

In certain embodiments of the method 500, for the conditional packet duplication, when the buffered data corresponds to the second PDU set type, the PDCP entity submits at least one packet of the PDU set to only one RLC entity to refrain from duplicating the at least one packet of the PDU set.

In certain embodiments of the method 500, for the conditional packet duplication, when the buffered data corresponds to the second PDU set type, the PDCP entity submits a subset of the one or more packets of the PDU set to the one or more of the plurality of RLC entities configured for the corresponding DRB for packet duplication.

In certain embodiments of the method 500, for the conditional packet duplication, the method 500 further includes receiving a signal for activation or deactivation of PDCP duplication for the corresponding DRB, wherein the signal further indicates whether the activation or the deactivation is applicable to the first PDU set type, the second PDU set type, or both the first PDU set type and the second PDU set type.

In certain embodiments, the method 500 further includes performing, by the PDCP entity of the wireless device, conditional RLC leg switching, based on whether the buffered data corresponds to the first PDU set type or the second PDU set type, wherein the plurality of RLC entities are associated to different logical channels (LCHs). The different LCHs may be configured with different parameters including at least one of different priority and different LCH mapping restrictions.

In certain embodiments, for the conditional RLC leg switching, the method 500 further includes: when the buffered data corresponds to the first PDU set type, the PDCP entity submits each of the one or more packets of the PDU set to a first group of at least one RLC entity of the plurality of RLC entities; and when the buffered data corresponds to the second PDU set type, the PDCP entity submits a subset of the one or more packets of the PDU set, or each of the one or more packets of the PDU set, to a second group of at least one RLC entity of the plurality of RLC entities. The subset may include, for example, essential packets (e.g., as designated by an application) of an important PDU set. In certain such embodiments, the first group partially overlaps with the second group.

In certain embodiments, the method 500 further includes determining whether the buffered data for transmission by the wireless device corresponds to the first PDU set type or the second PDU set type when a first packet of the PDU set arrives at a buffer of the wireless device.

In certain embodiments of the method 500, the first PDU set type comprises an important PDU set of an extended reality (XR) traffic flow, and wherein the second PDU set type comprises a non-important PDU set of the XR traffic flow.

Embodiments contemplated herein include an apparatus comprising means to perform one or more elements of the method 300 or the method 500. This apparatus may be, for example, an apparatus of a UE (such as a wireless device 702 that is a UE, as described herein).

Embodiments contemplated herein include one or more non-transitory computer-readable media comprising instructions to cause an electronic device, upon execution of the instructions by one or more processors of the electronic device, to perform one or more elements of the method 300 or the method 500. This non-transitory computer-readable media may be, for example, a memory of a UE (such as a memory 706 of a wireless device 702 that is a UE, as described herein).

Embodiments contemplated herein include an apparatus comprising logic, modules, or circuitry to perform one or more elements of the method 300 or the method 500. This apparatus may be, for example, an apparatus of a UE (such as a wireless device 702 that is a UE, as described herein).

Embodiments contemplated herein include an apparatus comprising: one or more processors and one or more computer-readable media comprising instructions that, when executed by the one or more processors, cause the one or more processors to perform one or more elements of the method 300 or the method 500. This apparatus may be, for example, an apparatus of a UE (such as a wireless device 702 that is a UE, as described herein).

Embodiments contemplated herein include a signal as described in or related to one or more elements of the method 300 or the method 500.

Embodiments contemplated herein include a computer program or computer program product comprising instructions, wherein execution of the program by a processor is to cause the processor to carry out one or more elements of the method 300 or the method 500. The processor may be a processor of a UE (such as a processor(s) 704 of a wireless device 702 that is a UE, as described herein). These instructions may be, for example, located in the processor and/or on a memory of the UE (such as a memory 706 of a wireless device 702 that is a UE, as described herein).

Embodiments contemplated herein include an apparatus comprising means to perform one or more elements of the method 400 or the method 500. This apparatus may be. for example, an apparatus of a base station (such as a network device 718 that is a base station, as described herein).

Embodiments contemplated herein include one or more non-transitory computer-readable media comprising instructions to cause an electronic device, upon execution of the instructions by one or more processors of the electronic device, to perform one or more elements of the method 400 or the method 500. This non-transitory computer-readable media may be, for example, a memory of a base station (such as a memory 722 of a network device 718 that is a base station, as described herein).

Embodiments contemplated herein include an apparatus comprising logic, modules, or circuitry to perform one or more elements of the method 400 or the method 500. This apparatus may be, for example, an apparatus of a base station (such as a network device 718 that is a base station, as described herein).

Embodiments contemplated herein include an apparatus comprising: one or more processors and one or more computer-readable media comprising instructions that, when executed by the one or more processors, cause the one or more processors to perform one or more elements of the method 400 or the method 500. This apparatus may be, for example, an apparatus of a base station (such as a network device 718 that is a base station, as described herein).

Embodiments contemplated herein include a signal as described in or related to one or more elements of the method 400 or the method 500.

Embodiments contemplated herein include a computer program or computer program product comprising instructions, wherein execution of the program by a processing element is to cause the processing element to carry out one or more elements of the method 400 or the method 500. The processor may be a processor of a base station (such as a processor(s) 720 of a network device 718 that is a base station, as described herein). These instructions may be, for example, located in the processor and/or on a memory of the base station (such as a memory 722 of a network device 718 that is a base station, as described herein).

FIG. 6 illustrates an example architecture of a wireless communication system 600, according to embodiments disclosed herein. The following description is provided for an example wireless communication system 600 that operates in conjunction with the LTE system standards and/or 5G or NR system standards as provided by 3GPP technical specifications.

As shown by FIG. 6, the wireless communication system 600 includes UE 602 and UE 604 (although any number of UEs may be used). In this example, the UE 602 and the UE 604 are illustrated as smartphones (e.g., handheld touchscreen mobile computing devices connectable to one or more cellular networks), but may also comprise any mobile or non-mobile computing device configured for wireless communication.

The UE 602 and UE 604 may be configured to communicatively couple with a RAN 606. In embodiments, the RAN 606 may be NG-RAN, E-UTRAN, etc. The UE 602 and UE 604 utilize connections (or channels) (shown as connection 608 and connection 610, respectively) with the RAN 606, each of which comprises a physical communications interface. The RAN 606 can include one or more base stations (such as base station 612 and base station 614) that enable the connection 608 and connection 610.

In this example, the connection 608 and connection 610 are air interfaces to enable such communicative coupling, and may be consistent with RAT(s) used by the RAN 606, such as, for example, an LTE and/or NR.

In some embodiments, the UE 602 and UE 604 may also directly exchange communication data via a sidelink interface 616. The UE 604 is shown to be configured to access an access point (shown as AP 618) via connection 620. By way of example, the connection 620 can comprise a local wireless connection, such as a connection consistent with any IEEE 802.11 protocol, wherein the AP 618 may comprise a Wi-Fi® router. In this example, the AP 618 may be connected to another network (for example, the Internet) without going through a CN 624.

In embodiments, the UE 602 and UE 604 can be configured to communicate using orthogonal frequency division multiplexing (OFDM) communication signals with each other or with the base station 612 and/or the base station 614 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 612 or base station 614 may be implemented as one or more software entities running on server computers as part of a virtual network. In addition, or in other embodiments, the base station 612 or base station 614 may be configured to communicate with one another via interface 622. In embodiments where the wireless communication system 600 is an LTE system (e.g., when the CN 624 is an EPC), the interface 622 may be an X2 interface. The X2 interface may be defined between two or more base stations (e.g., two or more eNBs and the like) that connect to an EPC, and/or between two eNBs connecting to the EPC. In embodiments where the wireless communication system 600 is an NR system (e.g., when CN 624 is a 5GC), the interface 622 may be an Xn interface. The Xn interface is defined between two or more base stations (e.g., two or more gNBs and the like) that connect to 5GC, between a base station 612 (e.g., a gNB) connecting to 5GC and an eNB, and/or between two eNBs connecting to 5GC (e.g., CN 624).

The RAN 606 is shown to be communicatively coupled to the CN 624. The CN 624 may comprise one or more network elements 626, which are configured to offer various data and telecommunications services to customers/subscribers (e.g., users of UE 602 and UE 604) who are connected to the CN 624 via the RAN 606. The components of the CN 624 may be implemented in one physical device or separate physical devices including components to read and execute instructions from a machine-readable or computer-readable medium (e.g., a non-transitory machine-readable storage medium).

In embodiments, the CN 624 may be an EPC, and the RAN 606 may be connected with the CN 624 via an S1 interface 628. In embodiments, the S1 interface 628 may be split into two parts, an S1 user plane (S1-U) interface, which carries traffic data between the base station 612 or base station 614 and a serving gateway (S-GW), and the S1-MME interface, which is a signaling interface between the base station 612 or base station 614 and mobility management entities (MMEs).

In embodiments, the CN 624 may be a 5GC, and the RAN 606 may be connected with the CN 624 via an NG interface 628. In embodiments, the NG interface 628 may be split into two parts, an NG user plane (NG-U) interface, which carries traffic data between the base station 612 or base station 614 and a UPF, and the S1 control plane (NG-C) interface, which is a signaling interface between the base station 612 or base station 614 and access and mobility management functions (AMFs).

Generally, an application server 630 may be an element offering applications that use internet protocol (IP) bearer resources with the CN 624 (e.g., packet switched data services). The application server 630 can also be configured to support one or more communication services (e.g., VOIP sessions, group communication sessions, etc.) for the UE 602 and UE 604 via the CN 624. The application server 630 may communicate with the CN 624 through an IP communications interface 632.

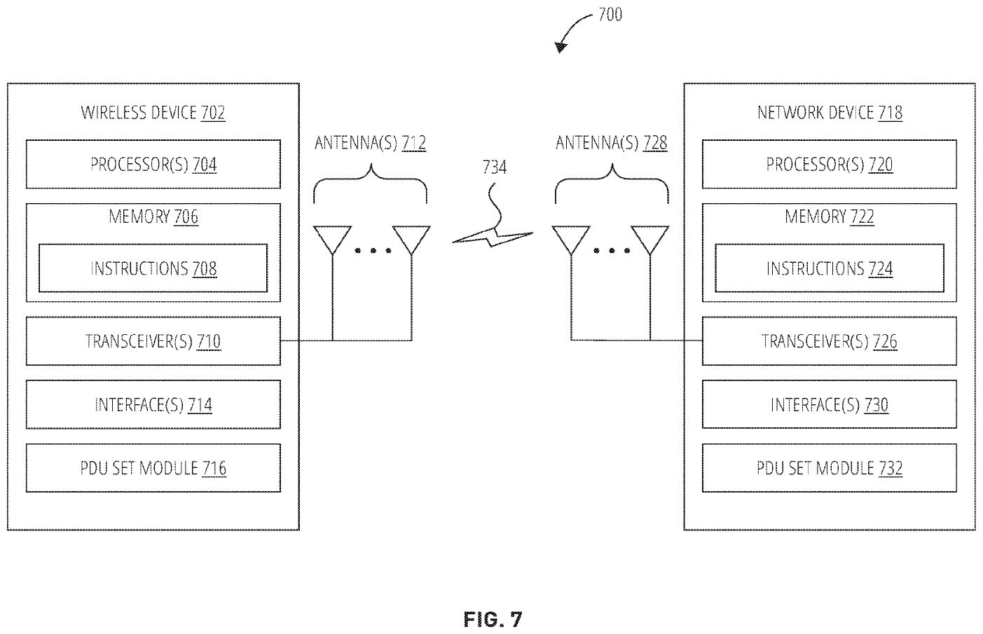

FIG. 7 illustrates a system 700 for performing signaling 734 between a wireless device 702 and a network device 718, according to embodiments disclosed herein. The system 700 may be a portion of a wireless communications system as herein described. The wireless device 702 may be, for example, a UE of a wireless communication system. The network device 718 may be, for example, a base station (e.g., an eNB or a gNB) of a wireless communication system.

The wireless device 702 may include one or more processor(s) 704. The processor(s) 704 may execute instructions such that various operations of the wireless device 702 are performed, as described herein. The processor(s) 704 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 702 may include a memory 706. The memory 706 may be a non-transitory computer-readable storage medium that stores instructions 708 (which may include, for example, the instructions being executed by the processor(s) 704). The instructions 708 may also be referred to as program code or a computer program. The memory 706 may also store data used by, and results computed by, the processor(s) 704. In certain embodiments, the memory 706 includes a buffer to store buffered uplink data.

The wireless device 702 may include one or more transceiver(s) 710 that may include radio frequency (RF) transmitter and/or receiver circuitry that use the antenna(s) 712 of the wireless device 702 to facilitate signaling (e.g., the signaling 734) to and/or from the wireless device 702 with other devices (e.g., the network device 718) according to corresponding RATs.

The wireless device 702 may include one or more antenna(s) 712 (e.g., one, two, four, or more). For embodiments with multiple antenna(s) 712, the wireless device 702 may leverage the spatial diversity of such multiple antenna(s) 712 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 702 may be accomplished according to precoding (or digital beamforming) that is applied at the wireless device 702 that multiplexes the data streams across the antenna(s) 712 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 702 may implement analog beamforming techniques, whereby phases of the signals sent by the antenna(s) 712 are relatively adjusted such that the (joint) transmission of the antenna(s) 712 can be directed (this is sometimes referred to as beam steering).

The wireless device 702 may include one or more interface(s) 714. The interface(s) 714 may be used to provide input to or output from the wireless device 702. For example, a wireless device 702 that is a UE may include interface(s) 714 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 710/antenna(s) 712 already described) that allow for communication between the UE and other devices and may operate according to known protocols (e.g., Wi-Fi®, Bluetooth®, and the like).

The wireless device 702 may comprise an XR device, which may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook).

The wireless device 702 may include a PDU set module 716. The PDU set module 716 may be implemented via hardware, software, or combinations thereof. For example, the PDU set module 716 may be implemented as a processor, circuit, and/or instructions 708 stored in the memory 706 and executed by the processor(s) 704. In some examples, the PDU set module 716 may be integrated within the processor(s) 704 and/or the transceiver(s) 710. For example, the PDU set module 716 may be implemented by a combination of software components (e.g., executed by a DSP or a general processor) and hardware components (e.g., logic gates and circuitry) within the processor(s) 704 or the transceiver(s) 710.

The PDU set module 716 may be used for various aspects of the present disclosure, for example, aspects of FIG. 3 and FIG. 5.

The network device 718 may include one or more processor(s) 720. The processor(s) 720 may execute instructions such that various operations of the network device 718 are performed, as described herein. The processor(s) 720 may include one or more baseband processors implemented using, for example, a CPU, a DSP, an ASIC, a controller, an FPGA device, another hardware device, a firmware device, or any combination thereof configured to perform the operations described herein.

The network device 718 may include a memory 722. The memory 722 may be a non-transitory computer-readable storage medium that stores instructions 724 (which may include, for example, the instructions being executed by the processor(s) 720). The instructions 724 may also be referred to as program code or a computer program. The memory 722 may also store data used by, and results computed by, the processor(s) 720.

The network device 718 may include one or more transceiver(s) 726 that may include RF transmitter and/or receiver circuitry that use the antenna(s) 728 of the network device 718 to facilitate signaling (e.g., the signaling 734) to and/or from the network device 718 with other devices (e.g., the wireless device 702) according to corresponding RATs.

The network device 718 may include one or more antenna(s) 728 (e.g., one, two, four, or more). In embodiments having multiple antenna(s) 728, the network device 718 may perform MIMO, digital beamforming, analog beamforming, beam steering, etc., as has been described.

The network device 718 may include one or more interface(s) 730. The interface(s) 730 may be used to provide input to or output from the network device 718. For example, a network device 718 that is a base station may include interface(s) 730 made up of transmitters, receivers, and other circuitry (e.g., other than the transceiver(s) 726/antenna(s) 728 already described) that enables the base station to communicate with other equipment in a core network, and/or that enables the base station to communicate with external networks, computers, databases, and the like for purposes of operations, administration, and maintenance of the base station or other equipment operably connected thereto.

The network device 718 may include a PDU set module 732. The PDU set module 732 may be implemented via hardware, software, or combinations thereof. For example, the PDU set module 732 may be implemented as a processor, circuit, and/or instructions 724 stored in the memory 722 and executed by the processor(s) 720. In some examples, the PDU set module 732 may be integrated within the processor(s) 720 and/or the transceiver(s) 726. For example, the PDU set module 732 may be implemented by a combination of software components (e.g., executed by a DSP or a general processor) and hardware components (e.g., logic gates and circuitry) within the processor(s) 720 or the transceiver(s) 726.

The PDU set module 732 may be used for various aspects of the present disclosure, for example, aspects of FIG. 4 and FIG. 5.

### Example System Architecture

In certain embodiments, 5G System (5GS) architecture supports data connectivity and services enabling deployments to use techniques such as Network Function Virtualization and Software Defined Networking. The 5G System architecture may leverage service-based interactions between Control Plane Network Functions. Separating User Plane functions from the Control Plane functions allows independent scalability, evolution, and flexible deployments (e.g., centralized location or distributed (remote) location). Modularized function design allows for function re-use and may enable flexible and efficient network slicing. A Network Function (NF) and its Network Function Services may interact with another NF and its Network Function Services directly or indirectly via a Service Communication Proxy. Another intermediate function may help route Control Plane messages. The architecture minimizes dependencies between the access network (AN) and the core network (CN). The architecture may include a converged core network with a common AN-CN interface that integrates different Access Types (e.g., 3GPP access and non-3GPP access). The architecture may also support a unified authentication framework, stateless NFs where the compute resource is decoupled from the storage resource, capability exposure, concurrent access to local and centralized services (to support low latency services and access to local data networks, User Plane functions can be deployed close to the AN), and/or roaming with both Home routed traffic as well as Local breakout traffic in the visited Public Land Mobile Network (PLMN).

The 5G architecture may be defined as service-based and the interaction between network functions may include a service-based representation, where network functions (e.g., Access and Mobility Management Function (AMF)) within the Control Plane enable other authorized network functions to access their services. The service-based representation may also include point-to-point reference points. A reference point representation may also be used to show the interactions between the NF services in the network functions described by point-to-point reference point (e.g., N11) between any two network functions (e.g., AMF and Session Management Function (SMF)).

FIG. 8 illustrates an example service based architecture 800 in 5GS according to one embodiment. The service based architecture 800 includes NFs such as a Network Slice Selection Function (show as NSSF 808), a Network Exposure Function (shown as NEF 810), a Network Repository Function (shown as NRF 814), a Policy Control Function (shown as PCF 812), a Unified Data Management Function (shown as UDM 826), an Authentication Server Function (shown as AUSF 818), an AMF 820, an SMF 822, for communication with a UE 816, a (R) AN 806, a User Plane Function (shown as UPF 802), and a Data Network (shown as DN 804). The NFs and NF services can communicate directly, referred to as Direct Communication, or indirectly via a Service Communication Proxy (shown as SCP 824), referred to as Indirect Communication. FIG. 8 also shows corresponding service-based interfaces including Nutm, Naf, Nudm, Npcf, Nsmf, Nnrf, Namf. Nnef, Nnssf, and Nausf, as well as reference points N1, N2, N3, N4, and N6. A few example functions provided by the NFs shown in FIG. 8 are described below.

The UPF 802 may act as an anchor point for intra-RAT and inter-RAT mobility, an external PDU session point of interconnect to the DN 804, and a branching point to support multi-homed PDU session. The UPF 802 may also perform packet routing and forwarding, perform packet inspection, enforce user plane part of policy rules, lawfully intercept packets, perform traffic usage reporting, perform QoS handling for user plane (e.g., packet filtering, gating, uplink/downlink rate enforcement), perform Uplink Traffic verification (e.g., Service Data Flow (SDF) to QoS flow mapping), perform transport level packet marking in the uplink and downlink, and perform downlink packet buffering and downlink data notification triggering. The UPF 802 may include an uplink classifier to support routing traffic flows to a data network.

FIG. 9A and FIG. 9B illustrate examples of protocol stacks in a 3GPP based wireless communication system. As used herein, a layer of a protocol stack may also be referred to as an entity (or simply by the name of the layer). For example, a physical (PHY) layer may be referred to as a PHY entity (or simply as a PHY), a media access control (MAC) layer may be referred to as a MAC entity (or simply as a MAC), a radio link control (RLC) layer may be referred to as an RLC entity (or simply as an RLC), a packet data convergence protocol (PDCP) layer may be referred to as a PDCP entity (or simply as a PDCP), a service data adaptation protocol (SDAP) layer may be referred to as an SDAP entity (or simply an SDAP), and a radio resource control (RRC) layer may be referred to as an RRC entity (or simply as an RRC).

FIG. 9A illustrates an example of a user plane protocol stack 900a for communication between a UE 902 and a base station 904 according to one embodiment. The user plane refers to a path through which data generated in an application layer (e.g., voice data, video data, or internet packet data) are transported. The user plane protocol stack 900a may be divided into a Layer 1 (L1) protocol and a Layer 2 (L2) protocol. In NR systems, the L1 protocol includes the PHY and the L2 protocol includes the MAC, RLC, PDCP, and SDAP.

The PHY may transmit or receive information used by the MAC over one or more air interfaces (i.e., physical channels and signals). The PHY offers to the MAC transport channels, the MAC offers to the RLC logical channels, the RLC offers to the PDCP RLC channels, the PDCP offers to the SDAP radio bearers, and the SDAP offers to 5GC QoS flows.

In NR systems, example services and functions of SDAP include mapping between a QoS flow and a data radio bearer and marking QoS flow ID (QFI) in both DL and UL packets. A single SDAP entity may be configured for each individual protocol data unit (PDU) session.

In NR systems, example services and functions of the PDCP for the user plane include sequence numbering, header compression and decompression, transfer of user data, reordering and duplicate detection, in-order delivery, PDCP PDU routing (in case of split bearers), retransmission of PDCP service data units (SDUs), ciphering/deciphering and integrity protection, PDCP SDU discard, PDCP re-establishment and data recovery for RLC AM, PDCP status reporting for RLC acknowledgement mode (AM), duplication of PDCP PDUs, and duplicate discard indication to lower layers.

In NR systems, the RLC supports three transmission modes: transparent mode (TM); unacknowledged mode (UM); and acknowledged mode (AM). The RLC configuration is per logical channel with no dependency on numerologies and/or transmission durations. Example services and functions of the RLC depend on the transmission mode and include transfer of upper layer PDUs, sequence numbering independent of the one in PDCP (UM and AM), error correction through automatic repeat request (ARQ) (AM only), segmentation (AM and UM) and re-segmentation (AM only) of RLC SDUs, reassembly of SDUs (AM and UM), duplicate detection (AM only), RLC SDU discard (AM and UM), RLC re-establishment, and protocol error detection (AM only).

In NR systems, example services and functions of the MAC include mapping between logical channels and transport channels, multiplexing/demultiplexing of MAC SDUs belonging to one or different logical channels into/from transport blocks (TBs) delivered to/from the physical layer on transport channels, scheduling information reporting, error correction through hybrid ARQ (HARQ) (one HARQ entity per cell in case of carrier aggregation (CA)), priority handling between UEs by dynamic scheduling, priority handling between logical channels of one UE by logical channel prioritization, and padding. A single MAC entity may support multiple numerologies, transmission timings, and cells. Mapping restrictions in logical channel prioritization control which of the numerology(ies), cell(s), and transmission timing(s) a logical channel can use. To accommodate different kinds of data transfer services offered by the MAC, multiple types of logical channels are defined.

Each logical channel type is defined by what type of information is transferred. The MAC PDU arrives to the PHY layer in the form of a transport block.

FIG. 9B illustrates an example of a control plane protocol stack 900b for communication between the UE 902, the base station 904, and a core network 906 (i.e., a mobility management entity (MME) in LTE or an access and mobility management function (AMF) in NR). The control plane refers to a path through which control messages used to manage calls by a UE and a network are transported.

The control plane protocol stack 900b includes PHY, MAC, RLC, PDCP, and RRC layers in an access stratum (AS). The control plane protocol stack 900b also includes a non-access stratum (NAS) comprising a set of protocols to convey non-radio signaling between the UE 902 and the core network 906. The NAS performs functions such as authentication, mobility management, and security control.

As discussed above, the PHY may transmit or receive information used by the MAC over one or more air interfaces. The PHY layer may further perform link adaptation or adaptive modulation and coding (AMC), power control, cell search (e.g., for initial synchronization and handover purposes), and other measurements used by higher layers, such as the RRC. The PHY may further perform error detection on the transport channels, forward error correction (FEC) coding/decoding of the transport channels, modulation/demodulation of physical channels, interleaving, rate matching, mapping onto physical channels, and Multiple Input Multiple Output (MIMO) antenna processing.

In NR systems, example services and functions of the RRC include broadcast of system information related to AS and NAS, paging initiated by 5GC or a RAN, establishment and maintenance or release of an RRC connection between the UE and the RAN, security functions including key management, establishment/configuration/maintenance/release of signaling radio bearers (SRBs) and data radio bearers (DRBs), mobility functions (including handover and context transfer, UE cell selection and reselection, and inter-RAT mobility, QoS management functions, UE measurement reporting and control of the reporting, detection of and recovery from radio link failure, and NAS message transfer.

The example services and functions of the PDCP for the control plane include sequence numbering, ciphering/deciphering and integrity protection, transfer of control plane data, reordering and duplicate detection, in-order delivery, duplication of PDCP PDUs, and duplicate discard indication to lower layers.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A user equipment (UE), comprising:
a memory to store buffered uplink data for a logical channel (LCH) of the UE; and
one or more processor in communication with the memory, the one or more processors to:
determine that the buffered uplink data corresponds to a first protocol data unit (PDU) set type:
generate an indication, from the UE for a base station, that the buffered uplink data at the LCH of the UE corresponds to the first PDU set type; and
process, at the UE, a dynamic grant from the base station corresponding to the first PDU set type.

2. The UE of claim 1, wherein the indication that the buffered uplink data at the LCH of the UE corresponds to the first PDU set type comprises an alteration of one or more fields in a buffer status report (BSR) to indicate a presence of the first PDU set type in at least one logical channel group (LCG).

3. The UE of claim 1, wherein the indication that the buffered uplink data at the LCH of the UE corresponds to the first PDU set type comprises:
a first logical channel identifier (LCID) or a first extended LCID (eLCID) for a buffer status report (BSR) media access control (MAC) control element (CE) to indicate that the buffered uplink data corresponds to the first PDU set type; and
a second LCID or a second eLCID for the BSR MAC CE to indicate that the buffered uplink data corresponds to a second PDU set type.

4. The UE of claim 1, wherein the one or more processors are further to receive, at the UE from the base station, a first scheduling request (SR) configuration and a second SR configuration for the LCH,
wherein the LCH corresponds to a data radio bearer (DRB) configured to carry data of both the first PDU set type and a second PDU set type,
wherein a first SR triggered by first uplink data of the first PDU set type from the LCH is sent based on the first SR configuration, and
wherein a second SR triggered by a second uplink data of the second PDU type from the LCH is sent based on the second SR configuration.

5. The UE of claim 4, wherein the indication that the buffered uplink data at the LCH of the UE corresponds to the first PDU set type comprises:
trigging the SR with the first SR configuration when a first PDU set of the first PDU set type arrives at a transmit buffer of the UE; and
triggering the SR with the second SR configuration when a second PDU set of the second PDU set type arrives at the transmit buffer of the UE.

6. The UE of claim 4, wherein the one or more processors are further to generate a buffer status report (BSR) media access control (MAC) control element (CE) to send from the UE to the base station, wherein the BSR MAC CE comprises buffer status information corresponding to both the first PDU set type and the second PDU set type.

7. The UE of claim 6, wherein the first PDU set type comprises an important PDU set of an extended reality (XR) traffic flow, and wherein the second PDU set type comprises a non-important PDU set of the XR traffic flow.

8. A base station, comprising:
a memory to store data of an indication from a user equipment (UE): and
one or more processors in communication with the memory, the one or more processors to:
process, at the base station, the data of the indication from the UE, the data indicating that buffered uplink data at a logical channel (LCH) of the UE corresponds to a first protocol data unit (PDU) set type:
based on the indication corresponding to the first PDU set type, determine a target reliability of one or more physical uplink shared channel (PUSCH) parameter; and
allocate, at the base station, a dynamic grant comprising the one or more PUSCH parameter to send to the UE for transmitting the buffered uplink data.

9. The base station of claim 8, wherein the one or more PUSCH parameter comprises at least one of a modulation and code scheme (MCS) and a number of repetitions for the UE to transmit the buffered uplink data.

10. The base station of claim 8, wherein the indication from the UE that the buffered uplink data at the LCH of the UE corresponds to the first PDU set type comprises an alteration of one or more fields in a buffer status report (BSR) that indicate a presence of the first PDU set type in at least one logical channel group (LCG).

11. The base station of claim 8, wherein the indication from the UE comprises:
a first logical channel identifier (LCID) or a first extended LCID (eLCID) in a buffer status report (BSR) media access control (MAC) control element (CE) to indicate when the buffered uplink data corresponds to the first PDU set type; and
a second LCID or a second eLCID in the BSR MAC CE to indicate when the buffered uplink data corresponds to a second PDU set type.

12. The base station of claim 8, wherein the one or more processors are further to configure the UE with a first scheduling request (SR) configuration and a second SR configuration for the LCH,
wherein the LCH corresponds to a data radio bearer (DRB) configured to carry data of both the first PDU set type and a second PDU set type,
wherein a first SR triggered by first uplink data of the first PDU set type from the LCH is sent based on the first SR configuration, and
wherein a second SR triggered by a second uplink data of the second PDU type from the LCH is sent based on the second SR configuration.

13. The base station of claim 12, wherein the one or more processors are further to monitor in which physical uplink control channel (PUCCH) the SR is received at the base station to determine whether the first SR configuration is used to indicate the first PDU set type or the second SR configuration is used to indicate the second PDU set type.

14. The base station of claim 12, wherein the one or more processors are further to process, at the base station, a buffer status report (BSR) media access control (MAC) control element (CE) from the UE comprising buffer status information corresponding to both the first PDU set type and the second PDU set type.

15. The base station of claim 14, wherein the first PDU set type comprises an important PDU set of an extended reality (XR) traffic flow, and wherein the second PDU set type comprises a non-important PDU set of the XR traffic flow.

16. A method for wireless communication by a user equipment (UE), the method comprising:
determining that buffered uplink data at a logical channel (LCH) of the UE corresponds to a first protocol data unit (PDU) set type:
indicating, from the UE to a base station, that the buffered uplink data at the LCH of the UE corresponds to the first PDU set type: and
processing, at the UE, a dynamic grant from the base station corresponding to the first PDU set type.

17. The method of claim 16, wherein indicating that the buffered uplink data at the LCH of the UE corresponds to the first PDU set type comprises altering one or more fields in a buffer status report (BSR) to indicate a presence of the first PDU set type in at least one logical channel group (LCG).

18. The method of claim 16, wherein indicating that the buffered uplink data at the LCH of the UE corresponds to the first PDU set type comprises:
using a first logical channel identifier (LCID) or a first extended LCID (eLCID) for a buffer status report (BSR) media access control (MAC) control element (CE) to indicate that the buffered uplink data corresponds to the first PDU set type; and
using a second LCID or a second eLCID for the BSR MAC CE to indicate that the buffered uplink data corresponds to a second PDU set type.

19. The method of claim 16, further comprising receiving, at the UE from the base station, a first scheduling request (SR) configuration and a second SR configuration for the LCH,
wherein the LCH corresponds to a data radio bearer (DRB) configured to carry data of both the first PDU set type and a second PDU set type,
wherein a first SR triggered by first uplink data of the first PDU set type from the LCH is sent based on the first SR configuration, and
wherein a second SR triggered by a second uplink data of the second PDU type from the LCH is sent based on the second SR configuration.

20. The method of claim 19, wherein indicating that the buffered uplink data at the LCH of the UE corresponds to the first PDU set type comprises:
trigging the SR with the first SR configuration when a first PDU set of the first PDU set type arrives at a transmit buffer of the UE; and
triggering the SR with the second SR configuration when a second PDU set of the second PDU set type arrives at the transmit buffer of the UE.

21-32. (canceled)
